(19) United States
(12) Patent Application Publication
(10) Pub. No.: US 2010/0041290 A1
(43) Pub. Date: Feb. 18, 2010

(54) SELECTIVELY PERMEABLE PROTECTIVE STRUCTURE AND METHODS FOR USE

(75) Inventors: Donna Lynn Visioli, Lower Gwynedd, PA (US); John Chu Chen, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/540,177

(22) Filed: Aug. 12, 2009

Related U.S. Application Data
(60) Provisional application No. 61/089,164, filed on Aug. 15, 2008.

(51) Int. Cl. B32B 27/12; B32B 3/26

(52) U.S. Cl. 442/1; 442/286; 428/319.3; 442/261; 442/394

(57) ABSTRACT

A package comprising an article and a selectively permeable protective structure and a method for limiting damage to the article due to corrosion or mold growth, comprising wrapping or covering the article in the selectively permeable protective structure. The selectively permeable structure comprises a membrane that may have a moisture vapor permeation value of at least 800 g-mil/m²/24 h and barrier to liquid water, and optionally a supporting substrate.

This application claims priority to U.S. provisional application No. 61/089164, filed Aug. 15, 2008; the entire disclosure of which is incorporated herein by reference.

This invention relates to a selective permeable structure for covering objects during transportation and storage and to a moisture-reduced package comprising an article and the structure.

### BACKGROUND

Equipment is often wrapped or packaged with film or fabric tarpaulins, hoods or other covers to prevent surface damage during transportation and storage. These covers may be prepared from high barrier (highly moisture impermeable) films and fabrics (see, e.g., http://www.heritagepackaging.com/productservices/barrierpackaging/bpba sics/bpbasics.htm).

Many relatively small items are shipped on pallets, that is, platforms that are easily moved by forklifts or small cranes. Pallets provide convenience in loading and unloading goods from shipping containers, and in moving smaller amounts of goods over shorter distances, such as within warehouses, or to deliver a retail quantity. The small items may be unpackaged or packaged, for example in bags or boxes, when they are placed on the pallets.

A loaded pallet must have integrity and stability, so that the goods are not damaged or lost during shipping. To provide the necessary integrity and stability, the pallet and its load have been typically wrapped together in film, for example overlapping layers of polyethylene stretch wrap that may be applied by machine or by hand. See, e.g., U.S. RE38429. Other generally practiced methods of providing integrity and stability to loaded pallets include wrapping the pallet and its load in heat shrinkable film, encasing the loaded pallet in a sheath or “hood” which may be heat shrinkable or stretchable, and containing the goods in a single carton box. These methods are sometimes referred to, individually or collectively, as “pallet unitizing”.

Using barrier films for wrapping small objects or articles in sealed bags is generally suitable since the object may be dried before being sealed in the bags and/or drying agents may be included inside the sealed bags. This approach is less suitable for large objects such as vehicles, boats, motors, machinery, industrial goods, pallets or containers holding smaller articles, and other bulky equipment because the covers are typically not hermetically sealed around the object and thorough drying of the object may not be feasible. This may be especially problematic during storage or when shipping by ship or railroad, because the large objects may be exposed to adverse weather conditions for long periods of time. Atmospheric moisture and/or rain may enter the space under the cover and be trapped and condense. With high barrier covers, there is no way for water to permeate back outside the cover, resulting in a buildup of moisture inside the cover, leading to the possibility of corrosion.

Large amounts of money are lost each year because of corrosion of, for example, iron, steel, and other metals. There are many factors affecting corrosion rate including moisture, oxygen, and salt presence. A common corrosion occurs due to electrochemical reactions at high humidity conditions. For example, when iron is exposed to moist air, it reacts with oxygen to form rust (iron oxide). The result of corrosion may be the formation of metal oxide that flakes off easily, causing extensive pitting thereby causing structural weakness and disintegration of the metal. Corrosion can also affect other properties of metal parts such as reducing conductivity or increasing surface roughness so that moving parts become unable to move freely.

In addition to corrosion of metals, mold growth may occur in the condensed moisture on the surface of the equipment.

Using a film or cover with a high water vapor transmission rate can prevent condensation of water inside the cover by allowing equilibration of the trapped moisture back into the surrounding atmosphere. Using such a film prevents or reduces rust formation and corrosion and reduces the opportunity for mold growth.

Various permeable materials having a wide range of mechanical and transport properties are known. Depending upon the particular application in which the permeable material is to be employed, however, certain combinations of properties are required. For a protective cover application, it is desirable that the material transports water vapor, but blocks the transport of liquid water or other fluids, and be lightweight and flexible over a broad temperature range. A need exists for a material that can be a flexible, solid material with membrane characteristics that facilitate the transport of water vapor, for example, from equipment inside a cover to the atmosphere and block entry of liquids such as water, oil or corrosive fluids.

Various references describe semipermeable materials produced from a variety of polymers that may be useful for protective covers. See e.g., U.S. Pat. No. 6,579,948.

Many previous permeable membranes are microporous (i.e., permeable due to the presence of microscopic pores through which vapor can pass). Microporous membranes, which may be laminated on or between nonwoven textiles, have increased permeability, but may not provide adequate barriers to liquids because of their nonselective permeability. Liquids under pressure may be able to penetrate the pores. Most microporous films are biaxially oriented, so only a small amount of shrinkage is possible, and they cannot be shrunk without losing their porosity. They may also have low tear strength and their surfaces may be easily fouled, thereby losing permeability.

Because no single material has emerged which satisfies all of the technical requirements and that presents a cost-effective alternative, it is desirable to provide a selectively permeable membrane or structure or layer that displays a combination of mechanical properties, low temperature flexibility, selective transport, ease of processability, and cost-effectiveness, so as to render it suitable for use as a protective cover for objects that limits corrosion and/or mold growth.

### SUMMARY OF THE INVENTION

A package comprises at least one article, a selectively permeable protective structure, and optionally a supporting substrate wherein the structure comprises, consists essentially of, or is produced from a selectively permeable membrane; the membrane comprises, consists essentially of, or is produced from a composition; the membrane has a moisture vapor permeation value (MVPV) of at least 800 g-mil/m²/24 h and high water-entry pressure; and the selectively permeable structure has a moisture vapor transmission rate (MVTR) of at least 500 g/m²/24 h. The MVPV is measured at 37.8° C. and 100% relative humidity according to ASTM F-1249.

A method for limiting damage to an article due to corrosion or mold growth, comprising wrapping or covering the article in a selectively permeable protective structure wherein the structure can be the same as that disclosed above.

### DETAILED DESCRIPTION OF THE INVENTION

The entire disclosures of all references are incorporated herein by reference and tradenames or trade marks are shown in upper case. “(Meth)acrylic acid” includes methacrylic acid and/or acrylic acid and “(meth)acrylate” includes methacrylate and/or acrylate. “Selectively permeable” means permeation is allowed only to certain molecules in a specific state such as vapor or gas and not to other molecules or in a different state such as liquid or solid. Such molecules can be dissolved or dispersed in the matrix of certain materials such as a film or sheet of the composition disclosed herein and thereafter be diffused or migrated through the material.

The selectively permeable membrane may have MVPV of at least 800, at least 900, at least 1200, at least 2000 or at least 4,000 g-mil/m²/24 h, or even up to 5000, 10000, or 15000 g-mil/m²/24 h, or even higher. MVPV measures moisture permeation of the membrane, which may be a film or sheet that is normalized to 1 mil thick.

Selectively permeable protective covers may have MVTR of at least 500, at least 600, at least 1000, or at least 2000 g/m²/24 h, or even higher. They may have MVTR up to about 3,000, about 5000 or about 10000 g/m²124 h, or even higher. MVTR measures total moisture vapor transmits through a film during a unit time, disregarding the structure thickness.

A selectively permeable protective structure provides a combination of mechanical properties, low temperature flexibility, selective transport, ease of processability, and cost-effectiveness.

The composition can be formed into a monolithic or continuous membrane that functions as a selectively permeable barrier. Monolithic continuous membranes, in contrast to microporous membranes, have high water-entry pressure and are waterproof and liquidproof. High water-entry pressure refers to >150 cm (or >150 cm or >150 cm) H₂O hydrostatic head, as described in DIN EN20811:92.

Therefore, monolithic membranes provide barriers to liquids such as water, while still allowing permeability to water vapor under appropriate conditions. A monolithic barrier is also effective at preventing exposure to liquids such as water, solvents, oils, corrosive fluids and the like, or particulates or solids, including dust, irritants, mold spores, allergens, pollen, animal dander, hair and the like.

The selectively permeable membrane may be selective to liquid penetrants depending on the size and polarity of the penetrants, i.e., has selectivity so as to be capable of allowing water to diffuse through at a higher rate than virtually all organic liquids having a molecular weight higher than that of methanol.

The selectively permeable composition may be an organic acid modified ionomer composition comprising, consisting essentially of, or produced from one or more ethylene acid copolymers or E/X/Y copolymers or ionomers of the acid copolymers; one or more carboxylic acids having from 4 to 36 carbon atoms, or salts thereof; and optionally 0.1 to 25 weight %, based on the composition, of one or more optional polymers which includes ethylene-containing polymers, propylene-containing polymers, or combinations thereof wherein

E represents copolymerized units of ethylene, X is present in about 2 to about 35 weight % of the copolymer and represents copolymerized units of at least one C₃ to C₈ α,β-ethylenically unsaturated carboxylic acid, and Y present in 0 to about 35 weight % of the copolymer and represents copolymerized units of a softening comonomer (softening means that the polymer is made less crystalline);

the carboxylic acid or salt thereof is present in the composition from about 1 to about 50 weight % and the carboxylic acid is optionally substituted with from one to three substituents independently selected from the group consisting of C₁-C₈ alkyl group, OH group, and OR¹ group;

each R¹ is independently C₁-C₈ alkyl group, C₁-C₆ alkoxyalkyl group, or COR² group;

each R² is independently C₁-C₈ alkyl group;

at least 50% of the combined acidic groups in the EIXIY copolymer and/or the organic acid may be nominally neutralized with metal ions to the corresponding salts; wherein at least 50% of the metal ions are alkali metal ions.

The acid copolymers used to make the compositions are preferably “direct” acid copolymers. “Direct” copolymers are polymers polymerized by adding all monomers simultaneously, as distinct from a graft copolymer, where another monomer is grafted onto an existing polymer, often by a subsequent free radical reaction.

Notable are E/X/Y copolymers wherein Y is 0 weight % of the polymer (that is, an E/X dipolymer). When present, Y is present in at least 0.1 weight %, or about 2 to about 35 weight % of the E/X/Y copolymer.

Examples of X include unsaturated acids such as (meth)acrylic acid, maleic acid, fumaric acid, itaconic acid, monoesters of fumaric acid or maleic acid (maleic half esters) including esters of C₁ to C₄ alcohols such as methyl, ethyl, n-propyl, isopropyl and n-butyl alcohols.

Examples of softening comonomers include alkyl acrylate, alkyl methacrylate, or combinations thereof wherein the alkyl groups have from 1 to 8, or 1 to 4, carbon atoms.

Ethylene acid copolymers may be produced by any methods known to one skilled in the art such as use of “co-solvent technology” disclosed in U.S. Pat. No. 5,028,674 or by employing somewhat higher pressures than those at which copolymers with lower acid levels may be prepared.

Specific acid copolymers include ethylene/acrylic acid dipolymers, ethylene/methacrylic acid dipolymers, and ethylene/acrylic acid/n-butyl acrylate, ethylene/methacrylic acid/n-butyl methacrylate, ethylene/acrylic acid/iso-butyl acrylate, ethylene/methacrylic acid/iso-butyl methacrylate, ethylene/acrylic acid/methyl acrylate, ethylene/methacrylic acid/methyl methacrylate, ethylene/acrylic acid/ethyl acrylate terpolymers, and ethylene/methacrylic acid/ethyl methacrylate terpolymers, or combinations of two or more thereof. Other acid copolymers include ethylene/maleic acid and ethylene/maleic acid monoester dipolymers; and ethylene/maleic acid monoester/n-butyl(meth)acrylate, ethylene/maleic acid monoester/methyl(meth)acrylate, ethylene/maleic acid monoester/ethyl(meth)acrylate terpolymers, or combinations of two or more thereof.

Ionomers are obtained by neutralization of an acid copolymer. Neutralizing agents including metal cations such as sodium or potassium ions are used to neutralize at least some portion of the acidic groups in the acid copolymer. Unmodified ionomers are prepared from the acid copolymers such as those disclosed in U.S. Pat. No. 3,262,272. “Unmodified” refers to ionomers that are not blended with any material that has an effect on the properties of the unblended ionomer. The acid copolymers may be used to prepare unmodified, melt processable ionomers by treatment with a metal compound. The unmodified ionomers may be nominally neutralized to any level such as about 15 to about 90% or about 40 to about 75% of the acid moieties.

The organic acids may be monobasic, having fewer than 36 carbon atoms, or salts thereof and may be present in the ionomer or composition from about 1 to about 50 weight %. The acids are optionally substituted with from one to three substituents independently selected from the group consisting of C₁-C₈ alkyl, OH, and OR¹ in which each R¹ is independently C₁-C₈ alkyl, C₁-C₆ alkoxyalkyl or COR²; and each R² is C₁-C₈ alkyl.

Examples of organic acids include C₄ to C₃₆ (such as C₃₄, C₄₋₂₆, C₆₋₂₂, or C₁₂₋₂₂) acids. At 100% nom inal neutral ization (i.e., sufficient metal compound is added such that all acid moieties in the copolymer and organic acid are nominally neutralized), volatility is not an issue and organic acids with lower carbon content may be used, though it is preferred that the organic acid (or salt) be non-volatile (not volatilize at temperatures of melt blending of the agent with the acid copolymer) and non-migratory (not bloom to the surface of the polymer under normal storage conditions (ambient temperatures)). Examples of organic acids include, but are not limited to, caproic acid, caprylic acid, capric acid, lauric acid, stearic acid, isostearic acid, behenic acid, erucic acid, oleic acid, and linoleic acid. Organic (fatty) acids include palmitic acid, stearic acid, oleic acid, erucic acid, behenic acid, isostearic acid, 12-hydroxystearic acid, or combinations of two or more thereof. Saturated organic acids, such as stearic acid and behenic acid, may be preferred.

Organic acids may be commercially available as a mixture of a named organic acid and a number of structurally different organic acids of varying lesser amounts. When a composition comprises a named acid, other unnamed acids may be present at levels conventionally known to be present in commercial supplies of the named acid.

Salts of any of these organic acids may include the alkali metal salts, such that the metal ions present in the final composition comprise at least 50% of alkali metal ions, including sodium, potassium salts and/or cesium salts.

The amount of basic metal compound capable of neutralizing acidic groups may be provided by adding the stoichiometric amount of the basic compound calculated to neutralize a target amount of acid moieties in the acid copolymer and organic acid(s) in the blend (hereinafter referred to as “% nominal neutralization” or “nominally neutralized”). Thus, sufficient basic compound is made available in the blend so that, in aggregate, the indicated level of nominal neutralization could be achieved. Greater than 50%, 60%, 70%, 80% or 90% (or even 100%) of the total acidic groups in the E/X/Y copolymers and organic acids may be nominally neutralized with metal ions; and the metal ions comprise at least 50 mole % alkali metal ions. Small amounts of salts of alkaline earth metal and/or transition metal ions may be present in addition to the alkali metals.

Metal compounds may include compounds of alkali metals, such as lithium, sodium, potassium, or cesium or combinations of such cations. Examples include sodium, potassium, cesium or any combination of sodium, potassium, and/or cesium, optionally including small amounts of other cations such as other alkali metal ions, transition metal ions or alkaline earth ions. Metal compounds of note include formates, acetates, nitrates, carbonates, hydrogencarbonates, oxides, hydroxides or alkoxides of the ions of alkali metals, especially sodium and potassium, and formates, acetates, nitrates, oxides, hydroxides or alkoxides of the ions of alkaline earth metals and transition metals. Of note are sodium hydroxide, potassium hydroxide, sodium acetate, potassium acetate, sodium carbonate and potassium carbonate.

The unmodified ionomers may be mixed with organic acids or salts thereof, metal compounds, and optional ethylene- or propylene-containing polymers, by any means known to one skilled in the art, to prepare compositions.

The modified ionomer composition may optionally comprise from about 0.1 to about 65, to about 55, to about 45, to about 35, to about 25, to about 15, or to about 10, weight %, based on the total amount of the modified ionomer composition, of one or more ethylene-containing polymers or propylene-containing polymers. For example, when the composition comprises 2 or 5 weight % to 25 weight % organic acids, the optional polymers may be present in the composition from about 10 to about 25 weight %. Blending with such polymers may provide better processability, improved toughness, strength, flexibility, and/or compatibility of the blend when adhering to a substrate as described below.

The optional polymers may include polyethylene (PE) homopolymers and copolymers, polypropylene (PP) homopolymers and copolymers, or combinations of two or more thereof.

PE homopolymers and copolymers may be prepared by a variety of methods, for example, the well-known Ziegler-Natta catalyst polymerization (e.g., U.S. Pat. No. 4,076,698 and U.S. Pat. No. 3,645,992), metallocene catalyzed polymerization, VERSIPOL catalyzed polymerization and by free radical polymerization. The polymerization may be conducted as solution phase processes, gas phase processes, and the like. Examples of PE polymers may include high density PE (HDPE), linear low density PE (LLDPE), low density PE (LDPE), very low or ultralow density PEs (VLDPE or ULDPE), lower density PE made with metallocene having high flexibility and low crystallinity (mPE). Metallocene technology is described in, for example, U.S. Pat. Nos. 5,272,236, 5,278,272, 5,507,475, 5,264,405, and 5,240,894.

The density of PE may range from about 0.865 g/cc to about 0.970 g/cc. Linear PE may incorporate a-olefin comonomers such as butene, hexene or octene to decrease density to within the density range so described. For example, a copolymer used may comprise a major portion (by weight) of ethylene that is copolymerized with another a-olefin having about 3-20 carbon atoms and up to about 20% by weight of the copolymer. Other α-olefins are propylene, 1-butene, 1-hexene, 4-methyl-1-pentene, 1-octene, 1-decene, 1-tetradecene, 1-octadecene, or in combinations of two or more.

The PE copolymer may also be an ethylene propylene elastomer containing a small amount of unsaturated compounds having a double bond. The term “PE” when used herein is used generically to refer to any or all of the polymers comprising ethylene described above.

Ethylene copolymers having small amounts of a diolefin component such as butadiene, norbornadiene, hexadiene and isoprene are also generally suitable. Terpolymers such as ethylene/propylene/diene monomer (EPDM) are also suitable.

PP polymers include homopolymers, random copolymers, block copolymers and terpolymers of propylene. Copolymers of propylene include copolymers of propylene with other olefins such as ethylene, 1-butene, 2-butene and the various pentene isomers, etc. and preferably copolymers of propylene with ethylene. Terpolymers of propylene include copolymers of propylene with ethylene and one other olefin.

PP homopolymers or random copolymers may be manufactured by any known process (e.g., using Ziegler-Natta catalyst, based on organometallic compounds, or on solids containing titanium trichloride). Block copolymers may be manufactured similarly, except that propylene is generally first polymerized by itself in a first stage and propylene and additional comonomers such as ethylene are then polymerized, in a second stage, in the presence of the polymer obtained during the first. Because the methods are well known to one skilled in the art, the description of which is omitted herein for the interest of brevity.

The ethylene-containing polymer may include ethylene copolymers obtained from copolymerization of ethylene with at least one polar monomer such as ethylene/vinyl acetate copolymer (EVA), ethylene/acrylic ester copolymers, ethylene/methacrylic ester copolymers, ethylene/vinyl acetate/CO copolymers, ethylene/acrylic ester/CO copolymers, ethylene/maleic anhydride copolymers, and/or mixtures of any of these.

EVA includes copolymers derived from the copolymerization of ethylene and vinyl acetate or the copolymerization of ethylene, vinyl acetate, and an additional comonomer. The vinyl acetate comonomer may have 2 to 45 or 6 to 30 weight % derived from vinyl acetate. An EVA may have a melt flow rate, measured in accordance with ASTM D-1238, of from 0.1 to 60 g/10 or 0.3 to 30 g/10 minutes. A mixture of two or more different EVAs may be used.

The optional polymer may optionally be modified by methods well known in the art, including modification with an unsaturated carboxylic acid or its derivatives, such as maleic anhydride or maleic acid.

Ethylene/alkyl(meth)acrylate copolymer includes copolymers of ethylene and one or more C₁₈alkyl(meth)acrylates. Examples of alkyl(meth)acrylates include methyl acrylate, ethyl acrylate and butyl acrylate. Examples of the copolymers include ethylene/methyl acrylate copolymer ethylene/ethyl acrylate copolymer, ethylene/butyl acrylate copolymer, or combinations of two or more thereof. Alkyl(meth)acrylate may be incorporated into an ethylene/alkyl(meth)acrylate copolymer 2 to 45, 5 to 45, 10 to 35, or 10 to 28, weight %.

Ethylene/alkyl(meth)acrylate copolymers may be prepared by processes well known to one skilled in the art using either autoclave or tubular reactors. See, e.g., U.S. Pat. Nos. 2,897,183, 3,404,134, 5,028,674, 6,500,888, and 6,518,365. Because the methods for making an ethylene/alkyl(meth)acrylate copolymer are well known, the description of which is omitted herein for the interest of brevity. Tubular reactor produced ethylene/alkyl(meth)acrylate copolymers are commercially available from E. I. du Pont de Nemours and Company, Wilmington, Del. (DuPont) such as ELVALOY AC. The ethylene/alkyl(meth)acrylate copolymers may vary significantly in molecular weight and the selection of the melt index (MI) grade of polymer may be by balancing the properties of the ethylene/alkyl(meth)acrylate copolymer with those of the neutralized organic acid and ethylene acid copolymer to provide the desired mix of permeability and structural properties needed for a specific variable permeability construction. A mixture of two or more different ethylene/alkyl(meth)acrylate copolymers may be used. Of note is a composition wherein at least one ethylene/alkyl(meth)acrylate copolymer is present in up to 15 weight %.

An anhydride-modified polymer may be used as the optional polymer and comprise a copolymer having an unsaturated dicarboxylic acid anhydride repeat unit, including maleic anhydride, citraconic anhydride, itaconic anhydride, tetrahydrophthalic anhydride, or combinations of two or more thereof. The modified copolymer may be obtained by known techniques, such as a grafting process in which a polymer selected from a PE homopolymer or copolymer, a PP homopolymer or copolymer, an EVA or an ethylene/alkyl(meth)acrylate copolymer, as disclosed above, is dissolved in an organic solvent with an unsaturated dicarboxylic acid anhydride or its functional equivalent and a radical generator, followed by heating with stirring; and a process in which all the components are fed to an extruder to provide a maleic-anhydride grafted ethylene copolymer. Grafting processes provide copolymers with from 0.1 to 3 weight % of anhydride units. These graft copolymers are available commercially from DuPont under the FUSABOND or BYNEL brand names.

Ethylene copolymers that include reactive functional groups such as maleic anhydride also may be readily obtained by a high-pressure free radical process, in which an olefin comonomer and a functional comonomer are directly copolymerized. A suitable high-pressure process is described, for example, in U.S. Pat. No. 4,351,931. This process allows for preparation of copolymers with greater than 3 weight %, for example, about 4 or 5 weight % to about 15 weight %, of anhydride units. These copolymers include olefin/maleate copolymers such as ethylene/maleic anhydride.

The composition disclosed above may be produced by any means known to one skilled in the art. It is substantially melt-processable and may be produced by combining one or more ethylene acid copolymers, one or more monobasic carboxylic acids or salts thereof, basic compound(s) and optionally one or more optional polymers to form a mixture; and heating the mixture under a condition sufficient to produce the composition. Heating may be carried out under a temperature in the range of from about 80 to about 350, about 100 to about 320, or 120 to 300° C. under a pressure that accommodates the temperature for a period from about 30 seconds to about 2 or 3 hours. For example, the composition may be produced by melt-blending an acid copolymer and/or ionomer thereof with one or more organic acids or salts thereof; concurrently or subsequently combining a sufficient amount of a basic metal compound capable of neutralization of the acid moieties to nominal neutralization levels greater than 50, 60, 70, 80, 90%, to near 100%, or to 100%; and optionally, combining an optional polymer disclosed above. A salt-and-pepper blend of components may be made or the components may be melt-blended in an extruder. For example, a twin-screw extruder may be used to mix and treat the acid copolymer and the organic acid (or salt) with the metal compound at the same time. It is desirable that the mixing is conducted so that the components are intimately mixed, allowing the basic metal compound to neutralize the acidic moieties.

Treatment of acid copolymers and organic acids with metal compounds in this manner (concurrently or subsequently), such as without the use of an inert diluent, may produce a composition without loss of processability or properties such as toughness and elongation to a level higher than that which would result in loss of melt processability and properties for the ionomer alone.

Other polymeric materials suitable for use in the selectively permeable composition include copolyetheresters, copolyetheramides, and thermoplastic polyurethanes, these classes of polymers being well known in the art.

Copolyetheresters are discussed in detail in patents such as U.S. Pat. Nos. 3,651,014, 3,766,146, 3,763,109 and 4,725,481. They comprise a multiplicity of recurring long chain units and short chain units joined head-to-tail through ester linkages, the long chain units being represented by the formula —OGO—C(O)RC(O)— and the short chain units being represented by the formula —ODO—C(O)RC(O)— where G is a divalent radical remaining after the removal of terminal hydroxyl groups from a poly(alkylene oxide)glycol having a molecular weight of about 400-6,000 and a carbon to oxygen ratio of about 2.0-4.3; R is a divalent radical remaining after removal of carboxyl groups from a dicarboxylic acid having a molecular weight less than about 300; and D is a divalent radical remaining after removal of hydroxyl groups from a diol having a molecular weight less than about 250; provided the short chain ester units are about 15-95 percent by weight of the copolyetherester. Copolyetherester polymers include those where the polyether segment is obtained by polymerization of tetrahydrofuran and the polyester segment is obtained by polymerization of tetramethylene glycol and phthalic acid. The molar ether:ester ratio may vary from 90:10 to 10:90, preferably 80:20 to 60:40. Copolyetheresters are available under the tradename HYTREL from Du Pont.

Copolyetheramides are also well known in the art as described in U.S. Pat. No. 4,331,786, for example. They comprise a linear and regular chain of rigid polyamide segments and flexible polyether segments, as represented by the general formula HO[C(O)—PA-C(O)—O—PE-O]H where PA is a linear saturated aliphatic polyamide sequence formed from a lactam or amino acid having a hydrocarbon chain containing 4 to 14 carbon atoms or from an aliphatic C₆-C₉ diamine, in the presence of a chain-limiting aliphatic carboxylic diacid having 4 to 20 carbon atoms; the polyamide has an average molecular weight between 300 and 15,000; and PE is a polyoxyalkylene sequence formed from linear or branched aliphatic polyoxyalkylene glycols, combinations thereof or copolyethers derived therefrom said polyoxyalkylene glycols having a molecular weight of less than or equal to 6,000 and n indicates a sufficient number of repeating units so that said polyetheramide copolymer has an intrinsic viscosity of from about 0.8 to about 2.05. The preparation of these polyetheramides comprises the step of reacting a dicarboxylic polyamide, the COOH groups of which are located at the chain ends, with a polyoxyalkylene glycol hydroxylated at the chain ends, in the presence of a catalyst such as a tetra-alkyl ortho-titanate having the general formula Ti(OR)₄, wherein R is a linear branched aliphatic hydrocarbon radical having 1 to 24 carbon atoms. The ether:amide ratios may vary from 90:10 to 10:90, preferably 80:20 to 60:40. Copolyetheramides are available under the tradename PEBAX from A to Chem.

The composition may additionally comprise from 0.01 to 15, 0.01 to 10, or 0.01 to 5, weight %, based on the composition weight, of additives including plasticizers, stabilizers including viscosity stabilizers and hydrolytic stabilizers, primary and secondary antioxidants, ultraviolet ray absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. These additives are described in the Kirk Othmer Encyclopedia of Chemical Technology.

The additives may be incorporated into the composition by any known process such as by dry blending, extruding a mixture of the various constituents, the conventional masterbatch technique, or the like.

The composition can further comprise a fire retardant such as a chemical additive including, but not limited to, phosphorous compounds, antimony oxides, and halogen compounds, particularly bromine compounds, and others well known in the art. A loading of such additives can be between 20 to 30, or about 25% (of the final air-dried composition or air-dried film weight).

The compositions may also comprise fillers, fibers, or pulps in added quantities that may be up to 30 to 40 weight % of the composition. These materials may provide reinforcement or otherwise modify the mechanical properties of the composition, without negatively impacting the selective permeability of the composition. Fillers include, for example, inorganic materials such as carbon black, TiO₂, calcium carbonate (CaCO₃). Fibers, including chopped fibers, include glass fibers, aramid fibers, carbon fibers and the like. Pulps include, for example aramid micropulps (micropulp has a volume average length from about 0.01 to about 100 micro-meters).

The polymer composition can be formed or incorporated into a film or sheet. Films may be made by known techniques such as casting the polymer composition onto a flat surface or into a film, extruding the molten polymer composition through an extruder to form a cast film, or extruding and blowing the polymer composition film to form an extruded blown film.

The films may have a thickness of from 1 to 2500 μm, with the preferred thickness for many protective cover applications being about 5 to 10 mils thick, or about 120 to 250 μm thick.

The protective structures can be in the form of, for example, tarpaulins, covers, and the like. The membrane from the composition can be present as a layer of material added to the protective structure, or as one component of a fabric incorporated into the protective structure. In some embodiments the polymer composition can be impregnated (including dispersion) in a substrate or the substrate can be impregnated in the polymer, while in other embodiments the polymer composition can be coated directly on a substrate utilizing fabric impregnation and coating techniques that are well known in the art.

The structure may be applied to a substrate comprising a carrier material, which may be a highly permeable and mechanically strong and tough layer as reinforcement. For example, the structure may be applied as a coating or a laminate to the carrier. Alternatively, a film comprising the structure may be laminated to the substrate. The substrate may be any material providing support, shape, esthetic effect, protection, surface texture, bulk volume, weight, or combinations of two or more thereof to enhance the functionality and handability of the structure.

When used with a substrate, the selectively permeable composition may have a thickness less than that when used as a self-supporting film. For example, coatings may have thickness from about 10 to about 250 μm.

A substrate can be a vehicle to aid in incorporating the selectively permeable composition or provide mechanical support for the membrane so that permeability is not hindered, preferably a substrate has water vapor diffusion that is greater than the water vapor diffusion of the selectively permeable membrane so that the water vapor diffusion characteristics of the structure are essentially provided by the selectively permeable composition. That is, the substrate does not substantially affect the passage of water vapor through the layered structure, and for example, may have a measured MVTR of at least 1.8, 4, 5, or even 10, Kg m²/24 hours.

Any support or substrate meeting these desired characteristics may be used with a layer of the selectively permeable structure arranged in overlying fashion. Examples include a textile or porous sheet material. For example, the membrane in the form of a film or sheet can be mechanically held or fastened in overlaying fashion adjacent to a textile. Alternatively, a layer of the composition may be adhered to a textile support in overlaying fashion in a discontinuous pattern, for example, by means of heat sealing, high frequency welding or adhesive. Sheets made from synthetic fiber spun fabrics, such as nonwoven textiles, may be used as a textile substrate. Cloth that is woven, knitted or the like is also suitable as a textile substrate.

For example, a fabric may comprise a 50% nylon-50% cotton blend woven fabric (also known as NYCO) such as those by Bradford Dyeing Association, Inc., in Bradford, R.I.

A fabric may comprise flame retardant(s), filler(s), or additive(s) disclosed above.

A substrate can be a porous sheet material or comprises a fluoropolymer. A substrate can be sheet material made with expanded polytetrafluoroethylene that is available from many companies, including W. L. Gore & Associates of Wilmington, Del. Other porous substrates include porous or microporous polyurethane films, certain flash spun non-woven fabrics, such as flash spun polypropylene, and other spun bonded polymer fabrics, filter materials from companies such as Millipore, nano- or micro-fiber structures, natural or synthetic fibers, other related supports that add dimensional stability, or combinations of two or more thereof.

While in one embodiment the substrate has been described as a textile, the substrate can be any other material that is capable of accommodating thereon one or a plurality of selectively permeable membrane layers, or accommodating therein a dispersion of the selectively permeable composition.

The structure can be in the form of a laminate wherein the composition is continuously adhered, either indirectly or through at least one intervening layer, to a substrate comprising the textile or porous sheet material of the support. The composition can also be dispersed throughout the substrate such as a loosely woven fabric where the composition fills gaps in the substrate and does not just adhere on the surface of a substrate. The substrate can be impregnated inside the selectively permeable membrane through lamination or coextrusion process to have the permeable compositions on both sides of the substrate.

Cellulosic materials such as paper webs (for example Kraft or rice paper), materials made from synthetic fiber spun fabrics, nonwoven textiles, microporous films, or even perforated films having large percentages of open areas such as perforated PE films, may be used as materials for the carrier(s) or substrate(s), for example. These materials may be reinforced with fibers. Microporous films of note may be prepared from polypropylene, polyethylene or combinations thereof. They may be monolayer or multilayer films (for example, three-layer films comprising an inner layer of polypropylene between two outer layers of polyethylene). Microporous films are available from Celgard, LLC, charlotte N.C. under the CELGARD tradename.

Suitable polymers for the a microporous film are (1) linear ultrahigh molecular weight polyethylene having an intrinsic viscosity of at least 18, preferably 18 to 39, deciliters/gram, (2) linear ultrahigh molecular weight polypropylene having an intrinsic viscosity of at least 6 deciliters/gram, and (3) mixtures of (1) and (2).

The microporous film may include a finely divided, particulate, substantially water-insoluble, inorganic filler, for example a siliceous filler, which is distributed throughout the matrix and which is present in amount 50 to 90%, particularly 50 to 85%, by weight of the film. The filler may be silica, precipitated silica, or silica having an average ultimate particle size of less than 0.1 μm and may occupy 35 to 80% of the total volume of microporous film. Because they have a relatively narrow range of pore sizes, films may be made by extruding a polymeric composition which contains an inorganic filler and a processing oil, e.g. a paraffinic oil, naphthenic oil or aromatic oil, uniformly distributed therein; followed by extraction of the processing oil, e.g. with trichloroethylene. Some films are disclosed, for example, in U.S. Pat. Nos. 4,937,115 and 3,351,495 and films are sold by PPG Industries under the tradename TESLIN.

Specific examples of porous or perforated films include a porous PE film having a porosity of about 55% and a pore size of about 0.25 microns, available under the tradename CELGARD K878 from Hoechst Celanese Corp; a porous PE film available under the tradename MSX 1137P from 3M Co.; and a filled porous PE film available under the designation Van Leer 10× from Van Leer Corp. TESLIN SP7 is a filled porous PE films containing about 60% silica, having a thickness of about 0.18 mm (0.007 inch), a tear strength measured as described above of about 90 g, a porosity of about 65%, an average pore size of about 0.1 micron and a largest pore size of 4 to 10 microns. TESLIN X457 is similar to TESLIN SP7 but is more porous. TESLIN SP10 is similar to Teslin SP7 but has a thickness of about 0.25 mm (0.010 inch). All three TESLIN films are available from PPG Industries. A perforated high density polyethylene film, 0.11 mm (4.5 mil) thick, with an open area of about 36%, is available under the tradename DELNET from Applied Extrusion Technologies.

The selectively permeable membrane or composition itself may be applied to any of these substrates as a film or membrane, a laminated layer or as a coating (via extrusion coating, spraying, painting or other appropriate application methods). The membrane or composition can be applied to one side or both sides of the substrate. In the case where the textile substrate is coated or laminated on one side, the membrane composition may be applied to the side that is directly exposed to the biological and/or chemical agents to provide an impermeable outer surface. Alternatively, in applications where mechanical wear or abrasion is likely, the membrane or composition may be applied to the side of the textile substrate opposite the side exposed to the mechanical wear to afford protection of the polymeric composition.

The membrane or composition can also be accommodated between two layers of textiles in a sandwich-like manner.

Several layer assemblies can also be assembled one above the other. For example, the configuration can comprise the selectively permeable membrane layer, a substrate layer, another selectively permeable membrane layer, another substrate layer, and so on, depending upon desired applications of the protective structure. Other configurations can comprise variations of the aforementioned sandwich configuration, including a plurality of selectively permeable membrane layers, a plurality of substrate layers, and so forth, including mixtures thereof.

Generally, the substrate and a layer of the selectively permeable may be arranged in overlaying or overlapping fashion to provide the protective structure. The composition can be in the form of a film or sheet and the film is mechanically held or fastened in overlaying fashion adjacent to the textile. Mechanical fastening includes the use of fasteners such as snaps, zippers, hook-and-loop fasteners and the like. Mechanical fastening also includes stitching or quilting using threads or fibers.

The selectively permeable membrane may be attached or adhered to the substrate by use of a compatible adhesive placed between the membrane layer and the substrate. To maintain water vapor permeability of the structure, in some embodiments the adhesive is present as a discontinuous layer between the membrane layer and the substrate, and in many cases, it may be applied as a series of adhesive dots that cover for example about 10 to about 40 percent of the substrate surface. The adhesive also may be applied selectively near the edges of the membrane and the substrate.

The selectively permeable membrane may also be attached to the substrate by heat sealing or high frequency (HF) welding. The laminate can be heat sealed (thermally bonded) using any known method, included heated presses and calenders and the like, or by applying heat to the layers and then subsequently pressing them together without additional heat. In each case, the softened layer or component subsequently bonds the film structure to the substrate. In either heat sealing or HF welding, the bonding of the film to the substrate may be continuous across the entire area of the film and substrate or it may be discontinuous. Discontinuous bonding may be accomplished by application of heat or HF radiation to selected portions of the area where the film overlays the substrate.

Coated fabrics, used previously as tarpaulins or other covers, may have at least one wear resistant outer layer that generally needs high flexibility, high resistance to marring from wear, abrasion, scuffing, and scratching, high mechanical strength and toughness. Coating compositions preferably exhibit good adhesion to fabrics and other substrates such as plastic films and cellulosic materials such as paper or paperboard. They also desirably exhibit good melt processability, good colorability, good printability, and high transparency and/or gloss. Previous coating compositions for these applications include plasticized or flexible polyvinyl chloride.

The organic acid-modified ionomer has good HF or radio frequency (RF) weldability, which is a desirable property for coating compositions. HF welding is an alternative to heat-bonding methods for adhering a film to a substrate such as the film itself, another film, or a textile fabric. HF welding involves heating only a HF-active component or HF-active layer of a structure such as a multilayer film sufficiently to soften that component. The selective heating is accomplished by treatment with high frequency radiation. HF welding is an alternative to heat-bonding methods for adhering a film to a substrate such as the film itself, another film, or a textile fabric. HF welding can bond a film in a fraction of the time required for heat-bonding methods.

The selectively permeable membrane may be formed at least partially in the substrate by impregnating the substrate with the membrane composition by either direct pressing of the composition into the substrate or by applying a molten mixture of the membrane composition to the substrate and then cooling the composition while it is in contact with the pores of the substrate.

The selectively permeable protective structure can be in the form of a laminate wherein the selectively permeable membrane is continuously adhered, either directly or through at least one intervening layer, to the substrate. For example, the selectively permeable membrane is a coating applied directly on the substrate. Such coating can be applied using spreading methods known in the art such as with a rubber doctor blade or with a slit extrusion machine.

Of note is where the membrane composition is applied to a substrate by, for example but not limitation, extrusion coating or laminated to a substrate by means of an inner layer applied in molten form to adhere the film to the substrate. Both are well known to one skilled in the art.

The membrane composition can be converted and applied to a substrate by a variety of techniques and processes. For example, a selectively permeable composition as described herein can be prepared as a powder with granular sizes of up to 600, alternatively up to 400, alternatively up to 200, μm in size. A powder composition can comprise granules that vary in size from about 100 to about 600 μm. The average particle size in a powder composition can be from about 150 to about 200 μm. The compositions can be milled, pulverized or otherwise processed by methods known in the art to provide a desired particle size suitable for application to a substrate.

The powder can be applied to a substrate by a technique such as powder scattering, wherein the powder is evenly distributed across a working width of a substrate and thereafter melted, smoothed, and cooled to provide a uniform coating of the composition on the substrate.

The laminate can further comprise a layer of adhesion-promoting or contaminant blocking substance that is selectively permeable, which could also be of an abrasion resistant polymer, positioned adjacent to the selectively permeable layer. For example, this substance may contain urethane functionality and can be about 2.5 to 12 μm thick. Other polymers that can be used in this layer include a variety of elastomers, reactive materials, and adhesives. Preferably the adhesion promoting polymer layer is present as a film, however, the layer can be a coating or an impregnation of the substrate. This additional adhesion promoting polymer layer is especially useful when the laminate is made by combining the layers of the laminate by thermal pressing, bonding, calendaring and the like. In this case, the layer of abrasion resistant polymer should be compatible with the selectively permeable layer so that when the items are thermally pressed they adhere together.

The protective structure may further comprise other layers such as adhesive layers, thermal insulation layers, cushioning layers, absorptive layers, reactive layers, and the like.

Insulation layers and cushioning layers may comprise an organic thermoplastic fiber-based material comprising, e.g., polyester, polyethylene or polypropylene. For example, the thermal insulating or cushioning layer is a fiberfill batt comprising polyester. A fiberfill batt sold as THERMOLITE ACTIVE ORIGINAL by DuPont is suitable. Alternatively, the thermal insulating layer may comprise melt-blown fibers, such as melt-blown polyolefins, sold as THINSULATE, by 3M. They may also include other materials such as fiberglass batts.

The mechanical properties and ease of processing of the selectively permeable composition, and its ability to transport water vapor and block liquids, optionally combined with a support substrate render protective structures thereof applicable for covering or enclosing articles during transport and storage.

A variety of structural configurations may be used to produce the package. For example, the variably permeable multilayer structure may be in the form of a flexible sheet of material. The sheet material may be wrapped around an article to be protected from corrosion in the same way conventional plastic films are used. Some possible structural configurations are as follows.

(1) Films or sheets of material comprising the selectively permeable structure that may be wrapped around or draped over the object(s) being packaged.

For example, the object, which may be a piece of equipment or a pallet and its load, may be wrapped in overlapping layers of film that may be applied by machine or by hand. These films may be relatively long and narrow and dispensed from rolls. The film may be stretchable or heat shrinkable. Wrapping an object with a linear stretch wrapping film by a machine, for example may be done by placing the object on a turntable and rotating it as the film is fed horizontally and its position is varied vertically to wrap the object in overlapping layers. The film may also be applied manually, as by an operator with a hand-held film dispenser who walks around the loaded pallet until a sufficient amount of film is applied.

A heat shrinkable film can be wrapped around an object and heat applied to it so that it shrinks to conform tightly around the object.

Other examples include substantially flat rectangular sheets having similar length and width that may be draped and optionally mechanically fastened in place (for example, with straps, ropes, elastic bands or the like) over the object, such as tarpaulins and the like.

These package forms may be preferred when a large variety of objects of different size and shape are to be packaged at a given time or location.

(2) Bags, pouches, hoods or sheathes comprised completely of the selectively permeable structure described herein or which comprise other materials such as other polymeric materials, woven or nonwoven textiles and the like and have windows, patches or areas thereon which comprise the selectively permeable structure.

These packaging forms are prepared from sheets or films that are formed into a concave shape that can accommodate the object to be packaged.

They include heat shrinkable hoods and pallet stretch hoods. Pallet stretch hoods are elastic sheaths that are stretched to fit over a pallet and its load. The pallet stretch hood then contracts, due to its elastic properties, and the forces of contraction provide integrity and stability to the loaded pallet.

These package forms may be preferred when a large number of objects of similar size and shape are to be packaged at a given time or location.

(3) Rigid or semi-rigid or flexible structures such as tubs, boxes, bins and the like, comprised completely of the selectively permeable structure or comprised in part of other materials having one or more windows of the variably permeable multilayer structure thereon.

(4) Lidding material comprised completely of the selectively permeable structure or comprised in part of other materials having one or more windows of the selectively permeable structure thereon. The lidding material may be used in combination with rigid or semi-rigid or flexible structures such as tubs, boxes, bins and the like to prepare a package comprising the selectively permeable structure.

(5) Patches of the selectively permeable structure over designed openings of packages to provide the desired permeability.

(6) Packages in which the selectively permeable structure is covered by a removable protective cover that allows a user to expose the selectively permeable structure to the environment at an appropriate time. For example, the protective cover may comprise a material with low adhesion to the selectively permeable structure that may be peeled away from the surface of the selectively permeable structure when desired. Alternatively, the cover may be removable material that overlays the selectively permeable structure, but is not adhered to it, in a package. For example, the protective cover may be a lid, flap or patch of protective (such as barrier) material that may be removed when desired. The protective cover may also be placed over a patch or window of the selectively permeable structure in a package.

This form of protective cover may provide extra protection of equipment during rain or other inclement weather, after which the barrier flap is removed to allow for moisture to vent through the selectively permeable membrane.

Numerous variations of these structures are also possible and such structures will become apparent to those skilled in the art upon reading this disclosure.

In the method for limiting damage to an article due to corrosion or mold growth, the article can be wrapped or covered in a selectively permeable protective structure disclosed above and the wrapping or covering may or may not be hermetic.

The following Examples are presented to demonstrate and illustrate, but are not meant to unduly limit the scope of, the invention.

### Examples

MI, the mass rate of flow of a polymer through a specified capillary under controlled conditions of temperature and pressure, was determined according to ASTM 1238 at 190° C. using a 2160 g weight, in g/10 minutes.

For samples with high water permeability (>100 g/m²-24 h), the water vapor transmission tests were conducted on a Mocon PERMATRAN-W 101 K, following ASTM D6701-01, at 37.8° C. at 100% relative humidity. For the other samples, the transmission tests were conducted on a Mocon PERMATRAN-W 700, following ASTM F1249-01. Moisture vapor permeation values (MVPV) on film samples are reported in g-mil/m²-24 h while MVTR are reported in g/m²-24 h. The compositions had MVPV of at least 800 (or at least 1200) g-mil/m²/24 h.

Another method for determining material “breathability,” or evaporative resistance, uses a Guarded Sweating Hotplate Test according to ASTM F1868, ISO 11092.

In order to illustrate the moisture permeance associated with a film layer involving a selectively permeable composition as described herein, extrusion cast films were prepared from the materials listed below.

### Materials Used

I-1: a terpolymer of ethylene, n-butyl acrylate (23.5 weight %) and methacrylic acid (9 weight %), neutralized to 52% (nominally) with sodium using sodium hydroxide, having a MI of 1.
I-2: a copolymer of ethylene and methacrylic acid (19 weight %), neutralized to 37% (nominally) with sodium using sodium hydroxide, having a MI of 2.6.
I-3: a copolymer of ethylene and methacrylic acid (10 weight %), neutralized to 55% (nominally) with sodium using sodium hydroxide, having an MI of 1.3.
I-4: a copolymer of ethylene and methacrylic acid (15 weight %), neutralized to 59% (nominally) with sodium using sodium hydroxide, having a MI of 0.93.
EAC-1: a terpolymer of ethylene, n-butyl acrylate (23.5 weight %) and methacrylic acid (9 weight percent), having an MI of 25. This was the base resin for Ionomer 1 prior to neutralization.
EAC-2: a dipolymer of ethylene, and methacrylic acid (19 weight %), having a MI of 300.
EAC-3: a terpolymer of ethylene, n-butyl acrylate (23.5 weight %) and methacrylic acid (9 weight %), having an MI of 200.
EAC-4: a terpolymer of ethylene, n-butyl acrylate (28 weight %) and acrylic acid (6.2 weight %), having an MI of 200.
EAC-5: a terpolymer of ethylene, n-butyl acrylate (15.5 weight %) and acrylic acid (8.5 weight %), having an MI of 60.
EAC-6: a terpolymer of ethylene, n-butyl acrylate (15.5 weight %) and acrylic acid (10.5 weight %), having an MI of 60.
HSA: 12-hydroxystearic acid commercially supplied by ACME-Hardesty Co.
ISA: Iso-stearic acid commercially supplied by Arizona Chemical.
BEH: behenic acid commercially supplied by Uniqema.
EMA-1: an ethylene copolymer containing 30 wt % methyl acrylate, with MI of 3 g/10 minutes.
EMA-2: an ethylene/methyl acrylate (24 weight %) dipolymer with MI of 20 g/10 minutes.
PE-1: low density polyethylene available under the designation DPE 1640 from DuPont Performance Elastomers.
Base MB-1: A blend of 59.5 weight % Na₂CO₃ in an ethylene/methylacrylic acid (10 weight %) copolymer with MI of 450 g/10 minutes.
Base MB-2: A blend of 50% K₂CO₃ in EMA-2.
Base MB-3: A 50% K₂CO₃ solution in water.

### Examples 1-4

Employing a Werner & Pfleiderer twin-screw extruder, I-1 was melt blended with 40 weight % of potassium stearate and additional potassium hydroxide to bring the composition to nominally 100% neutralization to provide Example 2. Other examples in Table 1 were prepared similarly, using the indicated ionomer or ethylene acid copolymer blended with the indicated fatty acid modifier and brought to 100% nominal neutralization with potassium hydroxide.

TABLE 1

| | | | WVPV |
|---|---|---|---|
| Example | Ionomer | Modifier (wt %)* | (g-mil/m²-24 h) |
| 1 | I-2 | K stearate (40) | 5,387 |
| 2 | I-1 | K stearate (40) | 5,279 |
| 3 | I-2 | K iso-stearate (20) | 10,290 |
| 4 | I-2 | K iso-stearate (40) | 78,535 |

*Examples were brought to 100% nominal neutralization with KOH.

### Examples 5-9

Additional film examples were prepared by extrusion casting. The units shown in Table 2 are wt %, except WVPV which is g-mil/m²-24 h.

TABLE 2

| Example | Acid copolymer | Modifier | Neutralizing agent | EMA-1 | WVPV |
|---|---|---|---|---|---|
| 5 | EAC-2 (70.63) | BEH (7.85) | MB-2 (21.25) | 0 | 9504 |
| 6 | EAC-2 (49.57) | BEH (21.24) | MB-2 (21.32) | 7.87 | 11401 |
| 7 | EAC-2 (77.57) | HSA (8.62) | K₂CO₃ (13.81) | 0 | 9844 |
| 8 | EAC-2 (67.81) | ISA (16.95) | K₂CO₃ (15.24) | 0 | 32145 |
| 9 | EAC-1(72.75) | ISA (18.19) | K₂CO₃ (9.06) | 0 | 10485 |

### Examples 10-17

The indicated materials were melt-blended in a twin-screw extruder at 20 lb/h (about 9 kg/h) throughput rate to provide compositions summarized in Table 3 below. Unless noted otherwise, the compositions were cast into films of 2 to 2.5 mils thickness (except that examples 14-16 were 4 mils) via a 28 mm W&P twin screw extruder.

TABLE 3

| | Polymer | EMA-1 | Modifier | Neutralizing Agent | MVPV |
|---|---|---|---|---|---|
| Example | (wt %) | (wt %) | (wt %) | (wt %) | (g-mil/m²-24 h) |
| 10 | I-2 (72.57) | 0 | ISA (18.14) | KOH (9.29) | 53920 |
| 11 | I-2 (83.3) | 0 | HSA (9.3) | KOH (7.4) | 5188 |
| 12 | I-2 (69.13) | 12.84 | HSA (3.63) | MB-2 (14.39) | 4219 |
| 13 | EAC-2 (75.38) | 0 | HSA (3.14) | KOH | 10333 |
| 14 | EAC-2 (57.72) | 20.33 | HSA (3.25) | MB-2 (18.70) | 4415 |
| 15 | EAC-2 (78.40) | 0 | HSA (3.27) | MB-3 (11.15) + MB-1 (7.19) | 5079 |
| 16 | EAC-2 (59.71) | 21.03 | HSA (3.36) | MB-3 (9.67) + MB-1 (6.22) | 5006 |
| 17 | I-2 (83.3) | 0 | HSA (9.3) | KOH (7.4) | |

### Moisture Vapor Transmission Rate (MVTR) of Multilaver Structure

This was measured by a method derived from the Inverted Cup method of MVTR measurement [ASTM E 96 Procedure BW, Standard Test Methods for Water Vapor Transmission of Fabrics (ASTM 1999)]. A vessel with an opening on top was charged with water and the opening was covered first with a moisture vapor permeable (liquid impermeable) layer of expanded-PTFE film (“ePTFE”), and then with the sample for which the MVTR was to be measured, and finally by woven fabric overlayer [NYCO 50:50 nylon/cotton blend, 6.7 oz/yd² (0.23 kg m²) treated with durable water repellant finish]. The three layers were sealed in place, inverted for 30 minutes to condition the layers, weighed to the nearest 0.001 g, and then contacted with a dry stream of nitrogen while inverted. After 19 h at 23° C., the sample was reweighed and the MVTR calculated (kg/m²·24 h) by means of the following equation:

MVTR=1/[(1/MVTR_{obs})−(1/MVTR_{mb})]

where MVTR_{obs} was the observed MVTR of the experiment and MVTR_{mb} was the MVTR of the ePTFE moisture barrier (measured separately). The reported values were the average of results from three replicate samples.

TABLE 4

| | Film thickness | MVTR |
|---|---|---|
| Composition | (mm) | (kg/m² · 24 h) |
| 11 | 0.035 | 7.5 |
| 17 | | 103 ± 5 |

### Examples 18 through 40

Employing a Werner & Pfleiderer twin-screw extruder, I-1 was melt blended with potassium stearate at 15 weight %, 30 weight % and 40 weight % to provide Examples 18 to 20. Similarly, I-3 was melt blended with potassium stearate at 15 weight %, 30 weight % and 40 weight % to provide Examples 21 to 23. Examples 24-27 were prepared similarly, using the indicated ionomer or ethylene acid copolymer blended with the indicated fatty acid salt modifier. Employing a Werner & Pfleiderer twin-screw extruder, I-2 was melt blended with 40 weight % of potassium stearate and additional potassium hydroxide to bring the composition to nominally 100% neutralization to provide Example 28. Other examples were prepared similarly, using the indicated ionomer or ethylene acid copolymer blended with the indicated fatty acid modifier and brought to 100% nominal neutralization with the hydroxide salt of the indicated cation.

The Examples were converted into monolayer films of approximately 3 mils in thickness through the blown film process. The films were measured for moisture vapor transmission rates. The permeation properties are described in Table 5.

TABLE 5

| Example | Polymer | Modifier (wt %) | MVPV (g-mil/m²-D) |
|---|---|---|---|
| C1 | EAC-5 | none | 2 |
| C2 | I-4 | none | 47 |
| 18 | I-1 | K Stearate (15%) | 930 |
| 19 | I-1 | K Stearate (30%) | 1,953 |
| 20 | I-1 | K Stearate (40%) | 5,394 |
| 21 | I-3 | K Stearate (15%) | 46.5 |
| 22 | I-3 | K Stearate (30%) | 1,178 |
| 23 | I-3 | K Stearate (40%) | 232 |
| 24 | EAC-5 | K Stearate (15%) | 507 |
| 25 | EAC-5 | K Stearate (45%) | 2,795 |
| 26 | EAC-5 | Na Stearate (15%) | 72 |
| 27 | EAC-5 | Na Stearate (45%) | 35 |
| 28 | I-2 | K Stearate (40%); 100% neutralized with K | 5,387 |
| 29 | I-1 | K Stearate (40%); 100% neutralized with K | 5,279 |
| 30 | I-2 | K iso-stearate (20%); 100% neutralized with K | 10,290 |
| 31 | I-2 | K iso-stearate (30%); 100% neutralized with K | 12,578 |
| 32 | I-2 | K iso-stearate (40%); 100% neutralized with K | 10,222 |
| 33 | I-2 | K iso-stearate (50%); 100% neutralized with K | 12,408 |
| 34 | I-2 | K iso-stearate (20%); 100% neutralized with K | 918 |
| 35 | I-2 | K iso-stearate (40%); 100% neutralized with K | 6,013 |
| 36 | EAC-1 | K iso-stearate (40%); 100% neutralized with K | 28,089 |
| 37 | I-2 | K iso-stearate (40%); 100% neutralized with K | 78,535 |
| 38 | I-2 | K iso-stearate (50%); 100% neutralized with K | 103,927 |
| 39 | I-2 | Na Stearate (40%); 100% neutralized with Na | 3,491 |
| 40 | I-4 | Na Stearate (40%); 100% neutralized with Na | 1,220 |

Copolyether and Copolyamide compositions are shown in Table 6.

TABLE 6

| Example | Polymer Type | Description |
|---|---|---|
| 41 | Copolyether ester | 45 wt % 1,4-butylene terephthalate, 55 wt % ethylene oxide/propylene oxide |
| | | copolyether terephthalate. Calculated ethylene oxide content of 33%. |
| 42 | Copolyether ester | 42 wt % 1,4-butylene terephthalate, 12 wt % 1,4-butylene isophthalate, 36 wt % |
| | | ethylene oxide/propylene oxide copolyether terephthalate, 10 wt % ethylene |
| | | oxide/propylene oxide copolyether isophterephthalate. Calculated ethylene oxide |
| | | content of 13%. |
| 43 | Copolyether ester | 32 wt % 1,4-butylene terephthalate, 9 wt % 1,4-butylene isophthalate, 46 wt % |
| | | ethylene oxide/propylene oxide copolyether terephthalate, 13 wt % ethylene |
| | | oxide/propylene oxide copolyether isophterephthalate. Calculated ethylene oxide |
| | | content of 17%. |
| 44 | Copolyester amide | PEBAX MV 1074 |
| 45 | Copolyester amide | PEBAX MH 1657 |
| C3 | Nylon 6 | CAPRON B135ZP |
| C4 | Nylon 6.66 | ULTRAMID C135 |
| C5 | Copolyester | SELAR PT 8307 |
| C6 | Copolyether ester | 70 wt % 1,4-butylene terephthalate, 30 wt % poly-(tetramethylene oxide) |
| | | terephthalate. Calculated ethylene oxide content of 0%. |
| C7 | Copolyether ester | 60 wt % 1,4-butylene terephthalate, 40 wt % poly-(tetramethylene oxide) |
| | | terephthalate. Calculated ethylene oxide content of 0%. |

The permeation properties are summarized in Table 7.

TABLE 7

| | | Film | MVPV |
|---|---|---|---|
| | | Gauge | (g-25 micron/ |
| Example | Polymer Type | (μ) | m²-day) |
| 41 | Copolyether ester 1 | 30 | 14463 |
| 41 | Copolyether ester 1 | 53 | 16635 |
| 41 | Copolyether ester 1 | 64 | 14109 |
| 42 | Copolyether ester 2 | 48 | 2261 |
| 43 | Copolyether ester 3 | 41 | 5115 |
| 44 | Copolyester amide 1 | 43 | 10698 |
| 45 | Copolyester amide 2 | 43 | 13106 |
| C3 | Nylon 6 | 20 | 651 |
| C4 | Nylon 6.66 | 22 | 809 |
| C5 | Copolyester | 25 | 169 |
| C6 | Copolyether ester 4 | 46 | 762 |
| C7 | Copolyether ester 5 | 46 | 822 |

A coextruded film comprising a layer of transmission-adjusting layer was made from a layer comprising I-2 and 4 weight % behenic acid where 93% of the acid groups were neutralized with Na ions (Example 46) and a layer comprising EMA-1. The polymers in the layers were cast into films by coextrusion with thickness shown in the table using a 28 mm W&P twin screw extruder. Moisture vapor transmission rate (MVTR) of the cast film was calculated at 100% RH and shown in Table 8.

TABLE 8

| | | MVTR |
|---|---|---|
| 46, mil | EMA-1, mil | (g/m²-day) |
| 0.1 | 0.9 | 648 |
| 0.2 | 0.8 | 715 |
| 0.25 | 0.75 | 753 |
| 0.4 | 0.6 | 899 |
| 0.5 | 0.5 | 1033 |
| 0.6 | 0.4 | 1213 |
| 0.75 | 0.25 | 1642 |
| 0.9 | 0.1 | 2540 |

### Corrosion Test

The following test was performed to evaluate the corrosion protection performance of films prepared from compositions with different permeation values.

A small wooden cage was designed with a lower open platform to support a carbon steel test coupon (2 inch×4 inch) and an upper open platform to support a small aluminum dish. Above the upper platform was a framework to support a headspace. The cage was designed so that air could circulate freely throughout the internal volume defined by the cage. Three cages were prepared, one for each test film.

Bags were prepared from the test films in Table 6 by folding and heat sealing the edges together so that the internal volume of the bag fit loosely around the cage with enough extra material so that the opening could be closed by rolling over. Each test film was 2 mils thick.

TABLE 9

| | Example | | |
|---|---|---|---|
| | C8 | 46 | 47 |
| Composition | PE-1 | 95.5 wt % I-2 + | 64 wt % EAC-2 + |
| | | 4.5 wt % | 15 wt % BEH + |
| | | Na stearate | 8.9 wt % EMA-2 + |
| | | | 12.1 wt % K₂CO₃ |
| MVPV | 20 | 1300 | 12000 |
| (g · mil/ | | | |
| m² · day) | | | |
| Film Type | cast | blown | cast |
| MVTR | 10 | 650 | 6000 |
| (g/m² · day) | | | |

For the test, the steel test coupons were polished with 600 grit grinding paper and cleaned with acetone. The coupons were labeled and pictures were taken before the test for comparison after the test. A test coupon was placed in the lower platform of each cage. A small sponge was placed in the aluminum dish in each cage and 30 g of water was adsorbed into each sponge. A test bag was placed around the cage and the opening rolled over and taped and held shut with a spring clamp. The opening was not hermetically sealed but free air exchange between the air inside and outside the bag through the opening was prevented. The test packages (cage inside closed bag) were placed in an oven set at 60° C. After 68 hours in the oven, the test packages were removed from the oven and visually inspected before opening to qualitatively assess the amount of moisture present inside the package. The packages were opened and the test coupons removed and assessed for the amount of surface corrosion on the upper and lower surfaces. Using ADOBE PHOTOSHOP 7.0, color photographs of the coupons were transformed into black-and-white images in which corroded areas were transformed to black and noncorroded areas were transformed to white. The fractional area of black (as a percentage) of the total area of the coupon was calculated according to standard procedures in the software. The results of the test are summarized in Table 10.

TABLE 10

| | | Corrosion | |
|---|---|---|---|
| | | (% area) | |
| Exam- | | upper | lower |
| ple | Level of Condensation | side | side |
| C8 | Significant fogging and condensed water droplets; | 16 | 5 |
| | sponge still moist | | |
| 46 | No fogging, some condensed water droplets; | 1 | 0.2 |
| | sponge appeared dried out after 48 hours | | |
| 47 | Film clear; Sponge appeared dried out after 24 hrs | 0.08 | 0.09 |

This test showed that higher water permeation films provided better corrosion protection compared to a low water permeation film. The severity of corrosion was inversely proportional to the moisture permeation value of the films.

1. A package comprising an article, a selectively permeable protective structure, and a supporting substrate wherein
the structure comprises or is produced from a selectively permeable membrane;
the membrane comprises or is produced from a composition, which comprises an ionomer, an organic acid or salt thereof, and optionally an optional polymer;
the membrane has a moisture vapor permeation value of at least 800 g-mil/m²/24 h and a water-entry pressure of at least 150 cm H₂O;
the ionomer is derived from one or more ethylene acid copolymer;
the acid copolymer is derived from ethylene, at least one C₃ to C₈ α,β-ethylenically unsaturated carboxylic acid, and a softening comonomer;
the organic acid is one or more carboxylic acids having from 4 to 36 carbon atoms; and
at least 50% of the combined acidic groups in the acid copolymer and the organic acid are nominally neutralized with metal ions to the corresponding salts and at least 50% of the metal ions are alkali metal ions.
the structure has a moisture vapor transmission rate of at least 500 g/m²/24 h; and
the substrate comprises textile or porous sheet material.

2. The package of claim 1 wherein the composition is coated onto or impregnated into the substrate; and the substrate and the selectively permeable structure are in overlying fashion.

3. The package of claim 2 wherein the structure further comprises a layer including fabrics of aramid, glass fiber, or combinations thereof.

4. The package of claim 2 wherein the substrate is one or more porous films, polyurethane films, flash spun non-woven fabrics, woven fabrics of synthetic fibers, natural fibers, scrims, or filter materials.

5. The article of claim 2 wherein the substrate is one or more flash spun polypropylene, woven fabrics of synthetic fibers, or natural fibers.

6. The package of claim 1 wherein the composition is an ionomer modified with an organic acid or salt thereof and optionally an optional polymer wherein
the ionomer is derived from one or more ethylene acid copolymer;
the acid copolymer is derived from ethylene, at least one C₃ to C₈ α,β-ethylenically unsaturated carboxylic acid, and a softening comonomer;
the organic acid is one or more carboxylic acids having from 4 to 36 carbon atoms; and
at least 50% of the combined acidic groups in the acid copolymer and the organic acid are nominally neutralized with metal ions to the corresponding salts and at least 50% of the metal ions are alkali metal ions.

7. The package of claim 6 wherein the structure has a moisture vapor transmission rate of at least 500 g/m²/24 h.

8. The package of claim 7 wherein at least 50% of the metal ions are sodium ions.

9. The package of claim 7 wherein at least 50% of the metal ions are potassium ions.

10. The package of claim 7 wherein the structure comprises the substrate having impregnated therein, incorporated therein, or laminated thereon, the structure or the composition.

11. The package of claim 10 wherein the structure has moisture vapor transmission rate of at least 4 Kg m²/24 hours; and the organic acid or salt thereof is present in the composition from 1 to 50 weight % and includes one or more saturated or unsaturated monobasic having fewer than 36 carbon atoms.

12. The package of claim 11 wherein the substrate includes one or more polyurethane films, flash spun non-woven fabrics, woven fabrics of synthetic fibers, woven fabrics of natural fibers, or filter materials.

13. The package of claim 11 wherein the substrate is one or more flash spun polypropylene, woven fabrics of synthetic fibers, or natural fibers.

14. The package of claim 11 wherein the structure has moisture vapor transmission rate of at least 5 Kg m²/24 hours; and at least of 60% of the acid moiety in the acid copolymer and the organic acid is neutralized with one or more alkali metal ions.

15. The package of claim 14 wherein the structure has moisture vapor transmission rate of at least 10 Kg m²/24 hours; the metal ion is preponderantly potassium ions; and the structure is a monolithic membrane.

16. The package of claim 15 further comprising at least one heat insulation layer, cushioning layer, or textile layer.

17. A method comprising wrapping or covering an article in a selectively permeable protective structure thereby limiting or reducing damage to the article due to corrosion or mold growth wherein
the structure comprises a selectively permeable membrane and optionally a supporting substrate;
the membrane has a moisture vapor transmission rate of at least 800 g-mil/m²/24 h and a water-entry pressure of at least 150 cm H₂O;
the membrane comprises or is produced from a composition, which comprises an ionomer, an organic acid or salt thereof, and optionally an optional polymer;
the ionomer is derived from one or more ethylene acid copolymer;
the acid copolymer is derived from ethylene, at least one C₃ to C₈ α,β-ethylenically unsaturated carboxylic acid, and a softening comonomer;
the organic acid is one or more carboxylic acids having from 4 to 36 carbon atoms; and
at least 50% of the combined acidic groups in the acid copolymer and the organic acid are nominally neutralized with metal ions to the corresponding salts and at least 50% of the metal ions are alkali metal ions.

18. The method of claim 17 wherein the structure comprises the substrate having impregnated therein, incorporated therein, or laminated thereon, the structure or the composition

19. The method of claim 18 wherein the substrate includes one or more polyurethane films, flash spun non-woven fabrics, woven fabrics of synthetic fibers, woven fabrics of natural fibers, or filter materials.

20. The method of claim 19 wherein at least 50% of the metal ions are sodium ions or potassium ions.
